(19) United States
(12) Patent Application Publication
(10) Pub. No.: US 2019/0301492 A1
(43) Pub. Date: Oct. 3, 2019

(54) MOTOR, BLOWER APPARATUS, AND VACUUM CLEANER

(71) Applicant: Nidec Corporation, Kyoto (JP)

(72) Inventors: Akikazu FUJIWARA, Kyoto (JP); Satoshi UEDA, Kyoto (JP)

(21) Appl. No.: 16/360,055

(22) Filed: Mar. 21, 2019

(30) Foreign Application Priority Data
Mar. 30, 2018 (JP) 2018-070024

(51) Int. Cl. F04D 29/66; F04D 29/26; F04D 29/54

(52) U.S. Cl. CPC F04D 29/668; F05D 2260/96; F04D 29/54; F04D 29/263

(57) ABSTRACT

A motor includes a rotor that is rotatable about a central axis extending in a vertical direction, a stator that is radially opposite to the rotor, and a housing to contain at least a portion of each of the rotor and the stator. The stator includes a core back and teeth each extending from the core back toward the central axis. The housing includes a top plate extending perpendicularly to the central axis, a tubular housing portion extending axially downward from a radially outer end of the top plate, and at least one projection extending axially downward from the top plate and located between adjacent ones of the teeth in a circumferential direction.

### CROSS REFERENCE TO RELATED APPLICATION

This application claims the benefit of priority to Japanese Patent Application No. 2018-070024 filed on Mar. 30, 2018. The entire contents of this application are hereby incorporated herein by reference.

### BACKGROUND OF THE DISCLOSURE

### 1. Field of the Disclosure

The present disclosure relates to a motor, a blower apparatus, and a vacuum cleaner.

### 2. Description of the Related Art

A known motor including a housing has been disclosed. A known electric blower includes a motor case containing a rotor and a stator, and a disk-shaped diffuser. The motor case is cylindrical, is open on one side in an axial direction, and has an internal space in which the rotor and the stator are housed. The diffuser is arranged at an opening portion of the motor case, and is arranged to close the opening portion. The diffuser is fixed to a flange portion arranged at an outer periphery of the opening portion of the motor case through screws.

To prevent vibration of a motor, an increase in rigidity of a housing is required. However, in the case of the known motor described above, for example, the motor case may not have sufficient rigidity. Thus, a vibration may easily occur.

### SUMMARY OF THE DISCLOSURE

A motor according to an example embodiment of the present disclosure includes a rotor that is rotatable about a central axis extending in a vertical direction, a stator that is radially opposite to the rotor, and a housing to contain at least a portion of each of the rotor and the stator. The stator includes a core back and teeth each extending from the core back toward the central axis. The housing includes a top plate extending perpendicularly or substantially perpendicularly to the central axis, a tubular housing portion extending axially downward from a radially outer end of the top plate, and at least one projection extending axially downward from the top plate and located between adjacent ones of the teeth in a circumferential direction.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a vertical sectional view of a blower apparatus according to an example embodiment of the present disclosure.

FIG. 2 is an overall perspective view of an example of a motor according to an example embodiment of the present disclosure.

FIG. 3 is a vertical sectional view of the motor according to an example embodiment of the present disclosure.

FIG. 4 is a horizontal sectional view of the motor according to an example embodiment of the present disclosure.

FIG. 5 is a vertical sectional view of a housing of the motor.

FIG. 6 is a perspective view of the housing of the motor.

FIG. 7 is a partial bottom view of a housing of a motor according to a first modification of the above example embodiment of the present disclosure.

FIG. 8 is a partial bottom view of a housing of a motor according to a second modification of the above example embodiment of the present disclosure.

FIG. 9 is a partial vertical sectional view of a housing of a motor according to a third modification of the above example embodiment of the present disclosure.

FIG. 10 is a partial bottom view of a housing of a motor according to a fourth modification of the above example embodiment of the present disclosure.

FIG. 11 is a vertical sectional view of a projecting portion of the housing of the motor according to the fourth modification and its vicinity.

FIG. 12 is a vertical sectional view of a projecting portion of a housing of a motor according to a fifth modification of the above example embodiment of the present disclosure and its vicinity.

FIG. 13 is a partial bottom view of a projecting portion of a housing of a motor according to a sixth modification of the above example embodiment of the present disclosure and its vicinity.

FIG. 14 is a vertical sectional view of the projecting portion of the housing of the motor according to the sixth modification and its vicinity.

FIG. 15 is a perspective view of a vacuum cleaner according to an example embodiment of the present disclosure.

### DETAILED DESCRIPTION OF THE EXAMPLE EMBODIMENTS

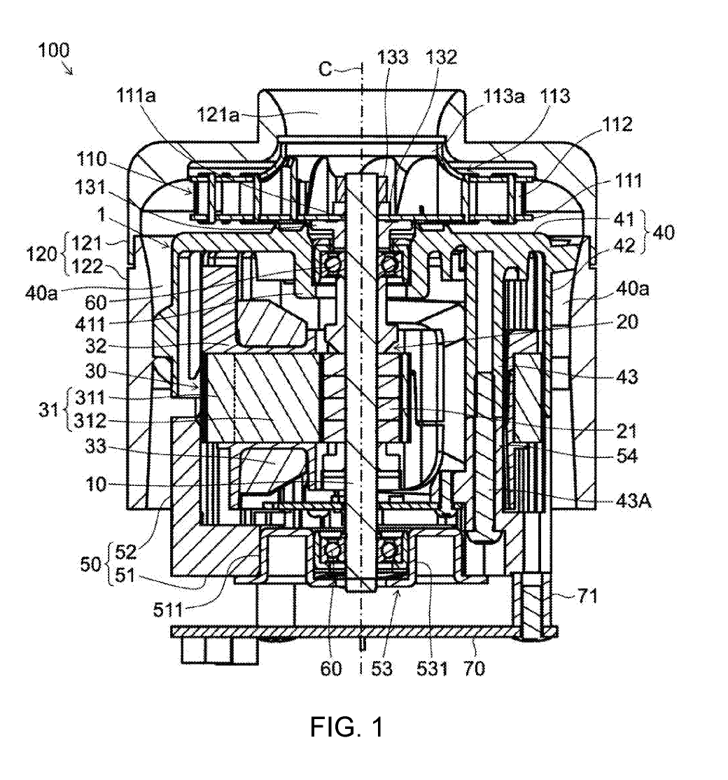

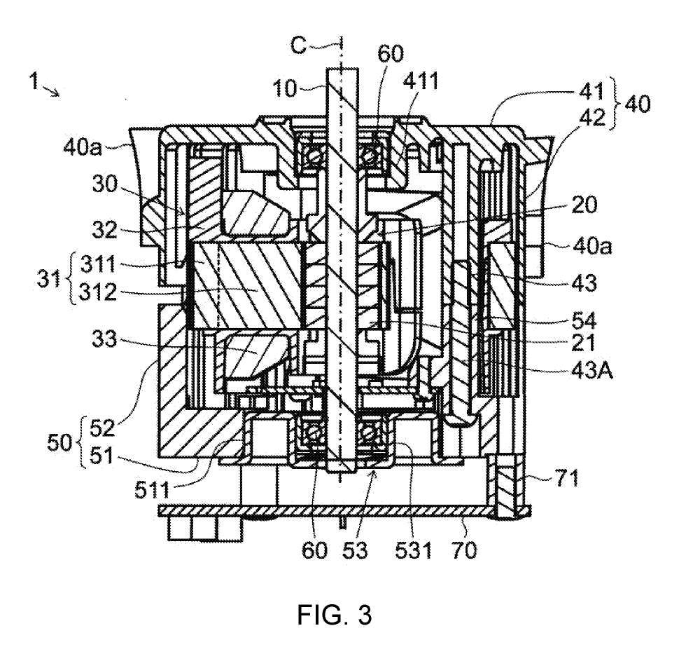

Hereinafter, example embodiments of the present disclosure will be described in detail with reference to the accompanying drawings. It is assumed herein that a direction in which a central axis of a motor extends is referred to simply by the term “axial direction”, “axial”, or “axially”, that directions perpendicular to the central axis of the motor and centered on the central axis are each referred to simply by the term “radial direction”, “radial”, or “radially”, and that a direction along a circular arc centered on the central axis of the motor is referred to simply by the term “circumferential direction”, “circumferential”, or “circumferentially”. A central axis of a blower apparatus coincides with the central axis of the motor. It is also assumed herein that an axial direction is a vertical direction for the sake of convenience in description, and the shape of each member or portion and relative positions of different members or portions will be described on the assumption that a vertical direction and upper and lower sides in FIGS. 1 and 3 are a vertical direction and upper and lower sides of each of the motor and the blower apparatus. The upper side of the blower apparatus corresponds to an inlet side, while the lower side of the blower apparatus corresponds to an outlet side. It should be noted, however, that the above definition of the vertical direction and the upper and lower sides is not meant to restrict in any way the orientation of, or relative positions of different members or portions of, a blower apparatus according to any example embodiment of the present disclosure when in use.

It is also assumed herein that, concerning a vacuum cleaner, a direction toward a floor and a direction away from the floor are referred to as a downward direction and an upward direction, respectively. The shape of each member or portion and relative positions of different members or portions will be described based on this assumption. It should be noted, however, that the above definition of the downward and upward directions is not meant to restrict in any way the orientation of, or relative positions of different members or portions of, a vacuum cleaner according to any example embodiment of the present disclosure when in use. Also note that a positional relationship may sometimes be described on the assumption that an upstream side and a downstream side are defined with respect to a direction in which air flows from the inlet side to the outlet side when the blower apparatus is in operation. It is also assumed herein that a section parallel to the axial direction is referred to by the term “vertical section”, and that a section at right angles to the axial direction is referred to by the term “cross section”. Note that the wordings “parallel”, “at right angles”, “perpendicular”, “perpendicularly”, etc., as used herein include not only “exactly parallel”, “exactly at right angles”, “exactly perpendicular”, “exactly perpendicularly”, etc., respectively, but also “substantially parallel”, “substantially at right angles”, “substantially perpendicular”, “substantially perpendicularly”, etc., respectively.

FIG. 1 is a vertical sectional view of a blower apparatus 100 according to an example embodiment of the present disclosure. The blower apparatus 100 includes a motor 1 and an impeller 110. The blower apparatus 100 further includes an impeller case 120.

The impeller 110 is arranged radially inside of the impeller case 120. The impeller 110 is fixed to a shaft 10 of the motor 1. The impeller 110 is arranged to rotate about a central axis C extending in the vertical direction together with the shaft 10.

The impeller 110 is defined by, for example, a metal member, and is circular when viewed in the axial direction. The impeller 110 includes a base plate 111, a plurality of blades 112, and a shroud 113.

The base plate 111 is arranged at an axially lower portion of the impeller 110. The base plate 111 is arranged to extend radially with the central axis C as a center. The base plate 111 is a member in the shape of a circular plate. The base plate 111 is arranged to support an axially lower portion of each blade 112.

The blades 112 are arranged on an axially upper surface of the base plate 111. The impeller 110 includes the plurality (e.g., twelve) of blades 112. The blades 112 are arranged in a circumferential direction on the axially upper surface of the base plate 111. The axially lower portion of each of the blades 112 is connected to the base plate 111. An axially upper portion of each of the blades 112 is connected to the shroud 113. Each blade 112 is a plate-shaped member arranged to vertically stand. Each blade 112 is arranged to extend radially outward from a radially inner end thereof while curving in the circumferential direction.

The shroud 113 is arranged axially above the blades 112. The shroud 113 is an annular plate-shaped member with each of a radially inner end and a radially outer end thereof being circular when viewed in the axial direction. The shroud 113 is arranged to curve upward as it extends radially inward from a radially outer end thereof. The shroud 113 includes an air inlet 113a which opens both upward and downward. The air inlet 113a is arranged in a radial center of the shroud 113. The shroud 113 is arranged to support the axially upper portion of each blade 112.

The blower apparatus 100 includes a spacer 131, a washer 132, and a nut 133.

The spacer 131 is arranged axially above an axially upper one of bearings 60 and axially below the base plate 111. The spacer 131 is fixed to the shaft 10. The base plate 111 of the impeller 110 is arranged on an upper surface of the spacer 131, and includes a hole portion 111a defined in a radial center of the base plate 111. The shaft 10 is arranged to pass through the hole portion 111a. The nut 133 is screwed to an axially upper end of the shaft 10 with the base plate 111 and the washer 132 being held between the spacer 131 and the nut 133. The impeller 110 is thus fixed to the shaft 10 through the nut 133.

The impeller case 120 is arranged axially above and radially outside of the motor 1. The impeller case 120 is arranged to contain the impeller 110. The impeller case 120 includes an upper case 121 and a lower case 122.

The upper case 121 is arranged axially above the motor 1, the impeller 110, and the lower case 122. The upper case 121 is in the shape of a cup opening axially downward. An axially lower portion of the upper case 121 is tubular, extending in the axial direction along the central axis C. An axially lower end of an outer circumferential portion of the upper case 121 is fixed to an axially upper end of an outer circumferential portion of the lower case 122.

The upper case 121 includes an air inlet 121a which opens both upward and downward. The air inlet 121a is arranged in a radial center of the upper case 121 at an axially upper end portion of the upper case 121. An axially lower portion of the air inlet 121a of the upper case 121 is arranged to radially overlap with an axially upper portion of the air inlet 113a of the shroud 113. The axially lower portion of the air inlet 121a of the upper case 121 is arranged to have a diameter smaller than a diameter of the axially upper portion of the air inlet 113a of the shroud 113.

The lower case 122 is arranged axially below the impeller 110 and the upper case 121 and radially outside of the motor 1. The lower case 122 is tubular, extending in the axial direction along the central axis C. An inner circumferential surface of the lower case 122 is arranged apart from an outer circumferential surface of a housing 40 of the motor 1 with a predetermined space therebetween. The inner circumferential surface of the lower case 122 is arranged to be in contact with an outer peripheral surface of each of a plurality of stationary vanes 40a.

Once the impeller 110 is driven by the motor 1 to rotate, air is sucked into the impeller 110 through the air inlet 121a of the impeller case 120. After being sucked into the impeller 110, the air is guided radially outward by the impeller 110, and is then blown out radially outwardly of the impeller 110. After being blown out radially outwardly of the impeller 110, the air is sent into a gap between the housing 40 and the lower case 122. After being sent into this gap, the air is guided axially downward in a gap between circumferentially adjacent ones of the stationary vanes 40a. Control of air flow can thus be accomplished. After passing through the gap between adjacent ones of the stationary vanes 40a, the air is discharged out of the blower apparatus 100 through an axially lower end of the lower case 122.

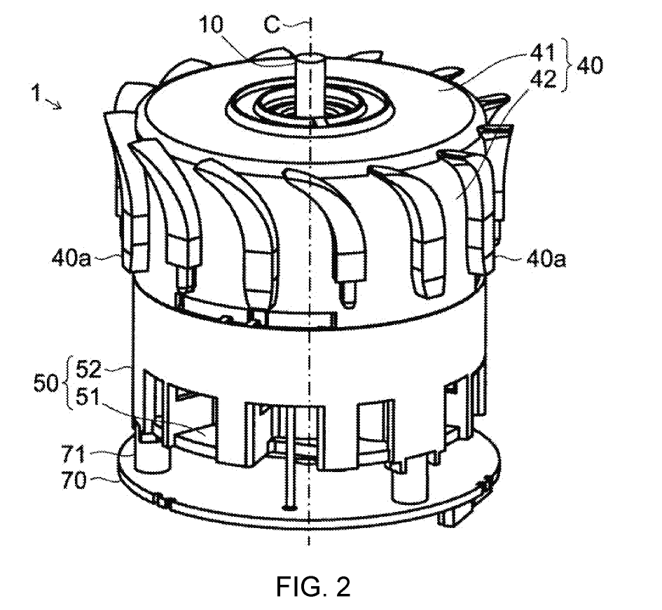

FIG. 2 is an overall perspective view of an example of the motor 1 according to an example embodiment of the present disclosure. FIG. 3 is a vertical sectional view of the motor 1 according to an example embodiment of the present disclosure. The motor 1 includes a rotor 20, a stator 30, and the housing 40. The motor 1 further includes the shaft 10, a cover portion 50, the bearings 60, and a circuit board 70.

The shaft 10 is arranged to extend along the central axis C extending in the vertical direction. The shaft 10 is a columnar member made of, for example, a metal, and arranged to extend in the vertical direction. The shaft 10 is supported by the bearings 60 to be rotatable about the central axis C with respect to the housing 40. That is, the shaft 10 is a rotating shaft of the rotor 20.

The rotor 20 is fixed to the shaft 10. The rotor 20 is arranged to rotate about the central axis C extending in the vertical direction. The rotor 20 includes a magnet 21. The magnet 21 is cylindrical, extending in the axial direction, and is fixed to the shaft 10 inserted inside of the magnet 21.

The stator 30 is arranged radially outside of the rotor 20 and radially inside of the housing 40. The stator 30 is arranged radially opposite to the rotor 20. The stator 30 includes a stator core 31, an insulator 32, and coils 33.

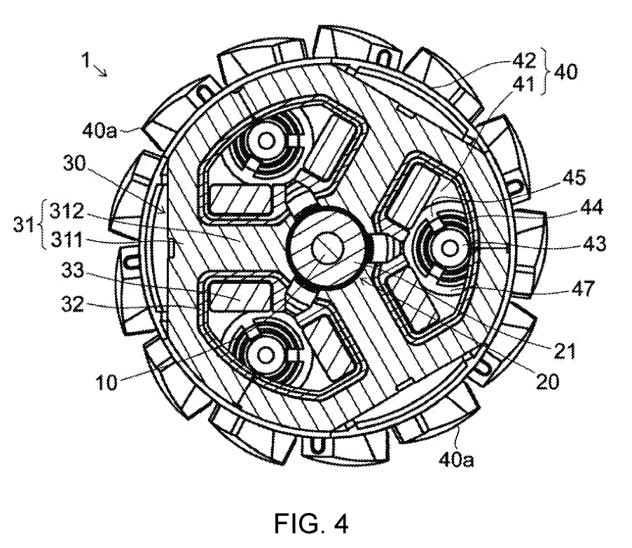

The stator core 31 includes a core back portion 311 and a plurality of tooth portions 312. That is, the stator 30 includes the core back portion 311 and the tooth portions 312, which together define the stator core 31. The core back portion 311 according to the present example embodiment is, for example, annular and centered on the central axis C. The tooth portions 312 are arranged to extend from the core back portion 311 toward the central axis C. The tooth portions 312 according to the present example embodiment are, for example, arranged to extend radially from the core back portion 311. In more detail, the tooth portions 312 are arranged to extend radially inward from an inner circumferential surface of the core back portion 311. The tooth portions 312 are arranged at predetermined intervals in the circumferential direction. In the present example embodiment, the number of tooth portions 312 included in the stator core 31 is three (see FIG. 4). The stator core 31 may be defined by a plurality of core pieces joined together. The stator core 31 may be defined by a plurality of electromagnetic steel sheets placed one upon another in the vertical direction.

Note that the number of tooth portions 312 may alternatively be two, or more than three. In the case where the number of tooth portions 312 is two, for example, the two tooth portions 312 are arranged radially opposite to each other with the central axis C in the center. That is, each of the tooth portions 312 is arranged to extend from the core back portion 311 toward the central axis C. Further, the core back portion 311 may alternatively be semicircular, and the two tooth portions 312 may be connected to the semicircular core back portion 311.

The insulator 32 is arranged on the stator core 31. The insulator 32 is arranged to surround an outer surface of each tooth portion 312. The insulator 32 is arranged between the stator core 31 and the coils 33. The insulator 32 is made of an insulating material, such as, for example, a resin. A portion of each tooth portion 312 which is opposed to the magnet 21 is not covered with the insulator 32.

Each coil 33 is defined by a conducting wire wound around a portion of the insulator 32 at a separate one of the tooth portions 312. That is, a portion of the insulator 32 is arranged between each tooth portion 312 and the corresponding coil 33. Electrical isolation between each tooth portion 312 and the corresponding coil 33 is achieved by a portion of the insulator 32. The coils 33 are arranged at predetermined intervals in the circumferential direction.

The housing 40 is an axially upper portion of the motor 1, and is arranged axially above and radially outside of the stator 30. The housing 40 is arranged to contain at least a portion of each of the rotor 20 and the stator 30. The housing 40 is made of, for example, a resin. The housing 40 includes a top plate portion 41 and a tubular housing portion 42.

The top plate portion 41 is arranged to extend perpendicularly to the central axis C. In more detail, the top plate portion 41 is in the shape of a disk, extending radially with the central axis C as a center. The tubular housing portion 42 is tubular, extending in the axial direction along the central axis C. The tubular housing portion 42, which is tubular, is arranged to extend axially downward from a radially outer end portion of the top plate portion 41. The top plate portion 41 is joined to an axially upper end portion of the tubular housing portion 42. The top plate portion 41 and the tubular housing portion 42 are defined by a single monolithic member. That is, the housing 40 is in the shape of a cup opening axially downward.

The top plate portion 41 of the housing 40 includes a bearing holding portion 411 arranged at a radial center thereof. The bearing holding portion 411 is recessed axially downward from an axially upper surface of the housing 40, and is arranged to have a circular cross section at right angles to the axial direction. At least one of the bearings 60 is held inside of the bearing holding portion 411.

The housing 40 further includes the plurality of stationary vanes 40a. The stationary vanes 40a are arranged on the outer circumferential surface of the housing 40. Each of the stationary vanes 40a is arranged to project in a direction away from the central axis C from the outer circumferential surface of the housing 40. The stationary vanes 40a are arranged at predetermined intervals in the circumferential direction, and each stationary vane 40a is arranged to extend in the axial direction. An axially upper portion of each stationary vane 40a is arranged to curve in the circumferential direction of the housing 40 with respect to an axially lower portion of the stationary vane 40a.

The cover portion 50 is an axially lower portion of the motor 1, and is arranged axially below the stator 30. The cover portion 50 includes a bottom plate portion 51 and a tubular cover portion 52.

The bottom plate portion 51 is arranged to extend perpendicularly to the central axis C. In more detail, the bottom plate portion 51 is in the shape of a disk, extending radially with the central axis C as a center. The tubular cover portion 52 is tubular, extending in the axial direction along the central axis C. The tubular cover portion 52, which is tubular, is arranged to extend axially upward from a radially outer end portion of the bottom plate portion 51. The bottom plate portion 51 is joined to an axially lower end portion of the tubular cover portion 52. The bottom plate portion 51 and the tubular cover portion 52 are defined by a single monolithic member. That is, the cover portion 50 is in the shape of a cup opening axially upward.

A fitting hole 511 is defined in a radial center of the bottom plate portion 51 of the cover portion 50. The fitting hole 511 is arranged to pass through the bottom plate portion 51 of the cover portion 50 in the axial direction. A bracket 53 is inserted into the fitting hole 511 from below, and is fixed in the fitting hole 511 through screws (not shown).

The bracket 53 includes a bearing holding portion 531 arranged at a radial center thereof. The bearing holding portion 531 is recessed axially downward from an axially upper surface of the bracket 53, and is arranged to have a circular cross section at right angles to the axial direction. At least one of the bearings 60 is held inside of the bearing holding portion 531.

The bearings 60 include at least a pair of bearings 60 arranged one above the other in the axial direction. The axially upper one of the bearings 60 is held by the bearing holding portion 411 of the housing 40. An axially lower one of the bearings 60 is held by the bearing holding portion 531 of the bracket 53. Each bearing 60 is defined by, for example, a ball bearing, but may alternatively be defined by, for example, a sleeve bearing. The pair of bearings 60 arranged one above the other in the axial direction are arranged to support the shaft 10 such that the shaft is rotatable about the central axis C with respect to the housing 40.

The circuit board 70 is arranged axially below the cover portion 50. The circuit board 70 is fixed on the axially lower side of the cover portion 50 so as to be spaced apart from the cover portion 50 by a predetermined distance through a spacer 71. A drive circuit (not shown) of the motor 1 is mounted on the circuit board 70. The circuit board 70 is electrically connected to the stator 30.

In the motor 1 having the above-described structure, once electric drive currents are supplied to the coils 33 through the circuit board 70, radial magnetic flux is generated in the stator core 31. A magnetic field generated by the magnetic flux of the stator 30 and a magnetic field generated by the magnet 21 interact with each other to produce a circumferential torque in the rotor 20. This torque causes the rotor 20 to rotate about the central axis C.

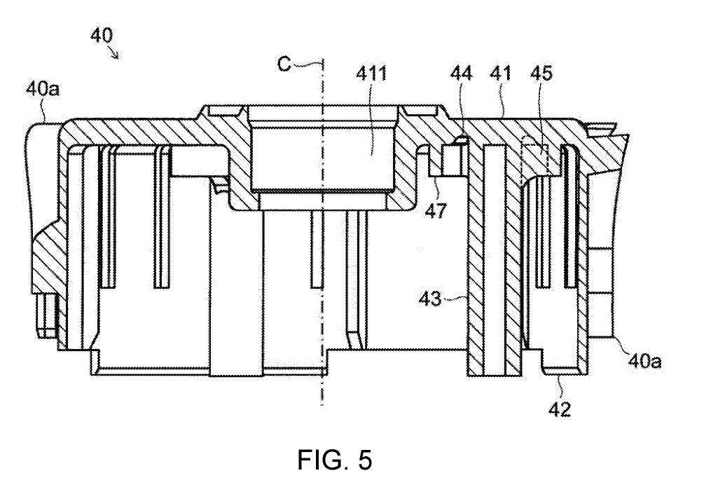

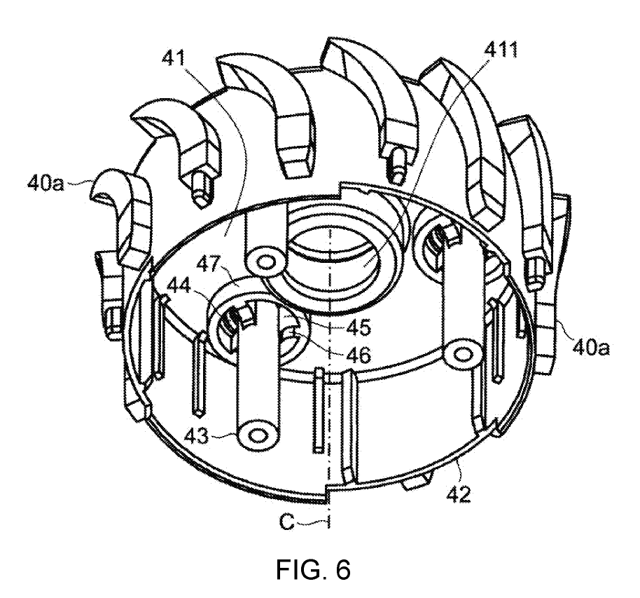

FIG. 4 is a horizontal sectional view of the motor 1 according to an example embodiment of the present disclosure. FIG. 5 is a vertical sectional view of the housing 40 of the motor 1. FIG. 6 is a perspective view of the housing 40 of the motor 1. The housing 40 includes projecting portions 43. That is, the housing 40 includes the top plate portion 41, the tubular housing portion 42, and the projecting portions 43.

Each projecting portion 43 is arranged at an inner portion of the housing 40. In more detail, the projecting portion 43 is arranged radially inside of the tubular housing portion 42 and axially below the top plate portion 41. The projecting portion 43 is arranged on an axially lower surface of the top plate portion 41. The projecting portion 43 is cylindrical, extending in parallel with the axial direction. In the present example embodiment, the projecting portion 43 is arranged to extend up to an axially lower end of the housing 40.

In the present example embodiment, the housing 40 includes three of the projecting portions 43. That is, the housing 40 includes at least one projecting portion 43 arranged to extend axially downward from the top plate portion 41. In the present example embodiment, the three projecting portions 43 are arranged to have the same axial dimension. Note that the projecting portions 43 may alternatively be arranged to have different axial dimensions. The three projecting portions 43 are arranged at predetermined intervals in the circumferential direction. Each projecting portion 43 is arranged between adjacent ones of the tooth portions 312 in the circumferential direction.

Referring to FIG. 4, each projecting portion 43 according to the present example embodiment is arranged between adjacent ones of the tooth portions 312 in the circumferential direction. In addition, each projecting portion 43 is arranged radially inside of the core back portion 311. That is, each projecting portion 43 is arranged in a region surrounded by the adjacent tooth portions 312 and the core back portion 311. This region is a dead space in the stator 30. Accordingly, the arrangement of the projecting portion 43 in the above region rather than in other regions contributes to preventing or minimizing an increase in the size of the housing 40. That is, a reduction in the size of the motor 1 can thus be achieved. More preferably, each projecting portion 43 is arranged between adjacent ones of the coils 33. More specifically, the projecting portion 43 is arranged in a region surrounded by the adjacent coils 33 and the core back portion 311. The arrangement of the projecting portion 43 in this region, which is a dead space, contributes to reducing the size of the motor 1.

According to the configuration of the above-described example embodiment, each projecting portion 43 is arranged radially closer to the central axis C than is an outer circumferential portion of the housing 40. That is, the housing 40 has, in an inner region in which the stator 30 is arranged, the projecting portions 43 as inner structures of the housing 40. An increase in rigidity of the housing 40 of the motor 1 can thus be achieved. This leads to reduced vibration of the motor 1.

Note that, although the number of projecting portions 43 of the housing 40 is three in the present example embodiment, the number of projecting portions 43 is not limited to three. The number of projecting portions 43 may be increased in accordance with the number of tooth portions 312. Also, the number of projecting portions 43 may be one or two. Also note that two or more of the projecting portions 43 may be arranged between adjacent ones of the tooth portions 312.

The motor 1 includes the cover portion 50, which is arranged axially below the stator 30 and is arranged axially opposite to the top plate portion 41. An axially lower end portion of the housing 40 is connected to an axially upper end portion of the cover portion 50. More specifically, an axially lower end portion of each projecting portion 43 is connected to the cover portion 50. This arrangement allows the housing 40 to be securely fixed to the cover portion 50 through the projecting portions 43.

The motor 1 includes the pair of bearings 60. One of the bearings 60 is held by the housing 40, while the other one of the bearings 60 is held by the cover portion 50. Fixing members 43A are arranged on the projecting portions 43. In the present example embodiment, each fixing member 43A is, for example, a screw. A separate one of the fixing members 43A is arranged on each of the three projecting portions 43. That is, the three fixing members 43A are arranged at predetermined intervals in the circumferential direction. Each fixing member 43A is a screw arranged to extend in the axial direction, and is fitted into the corresponding projecting portion 43 from axially below through the cover portion 50.

That is, at the projecting portions 43, the housing 40 and the cover portion 50 are connected to each other through the fixing members 43A. This arrangement allows the rigidity of the housing 40 to be increased by the projecting portions 43, and is able to improve the precision with which the pair of bearings 60 are arranged. In addition, with the housing 40 and the cover portion 50 being fixed to each other through the fixing members 43A, a reduction in the vibration of the motor 1 is achieved. Further, with each of the projecting portions 43 and the fixing members 43A being arranged between adjacent ones of the tooth portions 312 in the circumferential direction, a reduction in the size of the motor 1 can be achieved.

For example, in the present example embodiment, the cover portion 50 includes cover support portions 54 each of which is arranged axially opposite to the corresponding projecting portion 43 and is arranged to support the corresponding fixing member 43A. Each cover support portion 54 is cylindrical, extending in the axial direction from the bottom plate portion 51. The cover support portion 54 includes a through hole arranged to pass therethrough in the axial direction. The fixing member 43A can be inserted through this through hole. An axially upper end portion of the cover support portion 54 is arranged to be in axial contact with the axially lower end portion of the corresponding projecting portion 43, or is arranged axially opposite to the axially lower end portion of the corresponding projecting portion 43 with a gap therebetween. The cover portion 50 and the housing 40 are fixed to each other by the fixing members 43A being inserted through the through holes of the respective cover support portions 54.

Similarly to the projecting portions 43, each of the cover support portions 54 is arranged between adjacent ones of the tooth portions 312 in the circumferential direction. Further, each cover support portion 54 is arranged radially inside of the core back portion 311. That is, each cover support portion 54 is arranged in a region surrounded by the adjacent tooth portions 312 and the core back portion 311. This region is a dead space in the stator 30. Accordingly, the arrangement of the cover support portion 54 in the above region rather than in other regions contributes to preventing or minimizing an increase in the size of the cover portion 50. That is, a reduction in the size of the motor 1 can thus be achieved. More preferably, each cover support portion 54 is arranged between adjacent ones of the coils 33. More specifically, the cover support portion 54 is arranged in a region surrounded by the adjacent coils 33 and the core back portion 311. The arrangement of the cover support portion 54 in this region, which is a dead space, contributes to reducing the size of the motor 1.

The housing 40 includes recessed portions 44. Each recessed portion 44 is arranged around a separate one of the projecting portions 43 in the axially lower surface of the top plate portion 41. The recessed portion 44 is recessed axially upward from the axially lower surface of the top plate portion 41. That is, the housing 40 includes the recessed portions 44 each of which is recessed axially upward around a separate one of the projecting portions 43. With this arrangement, each recessed portion 44 acts as a so-called lightening hole. This contributes to preventing a sink mark from occurring around each projecting portion 43 when the housing 40 is molded using the resin. That is, an increase in the rigidity of the housing 40 around each projecting portion 43 can be achieved by preventing a depression (or a contraction) of the resin from occurring due to a sink mark around the projecting portion 43. This leads to reduced vibration of the motor 1.

The housing 40 includes ribs 45. The ribs 45 are arranged around each projecting portion 43 axially below the top plate portion 41. Each rib 45 is arranged to extend axially downward from the axially lower surface of the top plate portion 41, and to extend from the corresponding projecting portion 43 in a direction that is not parallel to the central axis C. In the present example embodiment, the housing 40 has three of the ribs 45 provided for each projecting portion 43. In the present example embodiment, the three ribs 45 arranged for each projecting portion are arranged to extend in a radial manner from an outer circumferential surface of the projecting portion 43. That is, the housing 40 includes at least one rib 45 arranged to extend from the projecting portion 43 in a direction that is not parallel to the central axis C. This arrangement leads to an increase in rigidity of a base portion of the projecting portion 43. This in turn makes it possible to improve an effect of reducing the vibration of the motor 1.

Further, at least a portion of at least one of the ribs 45 is arranged in a region surrounded by the core back portion 311 and adjacent ones of the tooth portions 312. This region is a dead space in the stator 30. Accordingly, the arrangement of at least a portion of the at least one of the ribs 45 in the above region rather than in other regions contributes to preventing or minimizing an increase in the size of the housing 40. That is, a reduction in the size of the motor 1 can thus be achieved. More preferably, at least a portion of at least one of the ribs 45 is arranged between adjacent ones of the coils 33. More specifically, at least a portion of at least one of the ribs 45 is arranged in a region surrounded by the adjacent coils 33 and the core back portion 311. The arrangement of at least a portion of the at least one of the ribs 45 in this region, which is a dead space, contributes to reducing the size of the motor 1.

In addition, an axially lower surface of each rib 45 includes a curved portion 46. The curved portion 46 is arranged at a junction of the rib 45 with the corresponding projecting portion 43. The curved portion 46 is arranged to curve axially downward as it approaches the corresponding projecting portion 43. This arrangement makes it possible to change the mass of the housing 40 in any desired manner, and makes it possible to adjust a characteristic value of the motor 1. Note that, although the curved portion 46 is arranged to curve in the axial direction in the present example embodiment, the curved portion 46 may alternatively be arranged to curve in a direction perpendicular to the axial direction. Also note that the axially lower surface of each rib 45 may alternatively be arranged to extend in a straight line in the present example embodiment.

The housing 40 includes wall portions 47. Each wall portion 47 is arranged around a separate one of the projecting portions 43 and around the corresponding ribs 45 axially below the top plate portion 41. In the present example embodiment, the housing 40 has one of the wall portions 47 provided for each projecting portion 43. Each wall portion 47 is connected to three of the ribs 45. That is, the housing 40 includes the ribs 45 each of which is arranged to extend from the corresponding projecting portion 43 in a direction that is not parallel to the central axis C, and the wall portions 47 connected to the ribs 45. Each wall portion 47 is arranged to extend axially downward from the axially lower surface of the top plate portion 41. The ribs 45 are arranged to connect each projecting portion 43 to the corresponding wall portion 47. This arrangement leads to an additional increase in the rigidity of the base portion of the projecting portion 43. Note that, in the present example embodiment, each rib 45 is arranged to extend up to an axially lower end of the corresponding wall portion 47.

Each wall portion 47 is tubular, extending axially downward, and is arranged to be concentric with the corresponding projecting portion 43. That is, the wall portion 47 is tubular, and is arranged to surround the corresponding projecting portion 43. This arrangement makes it possible to increase the rigidity of the base portion of each projecting portion 43 and the rigidity of a base portion of each rib 45 all the way around the projecting portion 43. In the present example embodiment, each wall portion 47 is cylindrical, extending in parallel with the axial direction. This leads to a uniform distribution of force acting on the projecting portion 43.

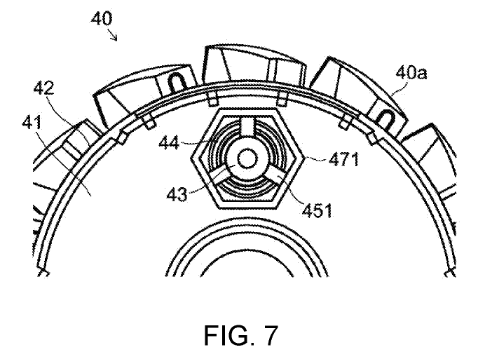

FIG. 7 is a partial bottom view of a housing 40 of a motor 1 according to a first modification of the present example embodiment. The housing 40 of the motor 1 according to the first modification includes ribs 451 and wall portions 471.

The ribs 451 are arranged around each of projecting portions 43 axially below a top plate portion 41. Each rib 451 is arranged to connect the corresponding projecting portion 43 and the corresponding wall portion 471 to each other.

Each wall portion 471 is tubular, and is arranged to surround the corresponding projecting portion 43. The wall portion 471 is tubular, extending axially downward in parallel with the axial direction, and is arranged to be concentric with the corresponding projecting portion 43. The wall portion 471 is in the shape of a polygon when viewed in the axial direction. The wall portion 471 is in the shape of a hexagon when viewed in the axial direction in the present example embodiment, but may alternatively be in the shape of another polygon such as, for example, a quadrilateral or an octagon, when viewed in the axial direction. This arrangement allows the shape of the wall portion 471 to be changed to any desired shape in accordance with objects contained in the housing 40. That is, it is possible to change the shape of the wall portion 471 to any desired shape in accordance with the shape and arrangement of a stator 30. It is also possible to change the shape of the wall portion 471 to any desired shape to adjust the characteristic value of the motor 1 to a desired frequency.

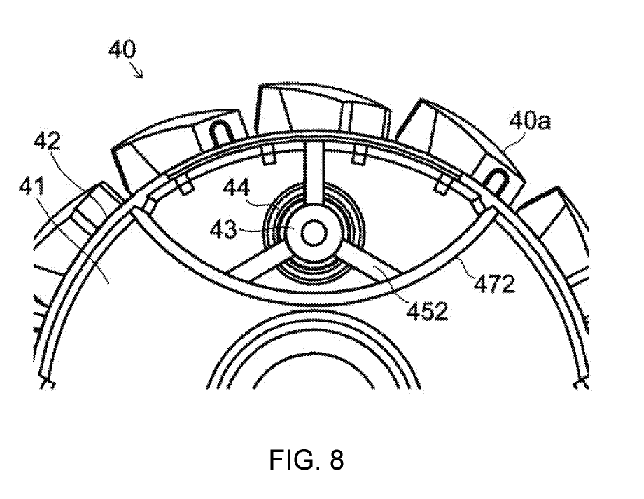

FIG. 8 is a partial bottom view of a housing 40 of a motor 1 according to a second modification of the present example embodiment. The housing 40 of the motor 1 according to the second modification includes wall portions 472 and ribs 452.

Each wall portion 472 is in the shape of an arc, and is connected to a tubular housing portion 42 at both end portions thereof in a direction that is not parallel to the axial direction. A corresponding projecting portion 43 is surrounded by the wall portion 472 and the tubular housing portion 42 on a plane that crosses the axial direction.

The ribs 452 are arranged around each projecting portion 43 axially below a top plate portion 41. The housing 40 has three of the ribs 452 provided for each projecting portion 43. Two of the three ribs 452 are arranged to connect the corresponding projecting portion 43 and the corresponding wall portion 472 to each other. The remaining rib 452 is arranged to extend radially outward to be connected to the tubular housing portion 42. That is, the motor 1 has the ribs 452 arranged at an inner portion of the housing 40. The rib 452 is arranged to connect the projecting portion 43 and the tubular housing portion 42 to each other. With this arrangement, increases in rigidity of the top plate portion 41 and rigidity of a base portion of each projecting portion 43 can be achieved through the ribs 452, the tubular housing portion 42, and the wall portions 472. Further, an increase in rigidity of the tubular housing portion 42 and the top plate portion 41 can be achieved. This makes it possible to improve an effect of reducing vibration of the motor 1.

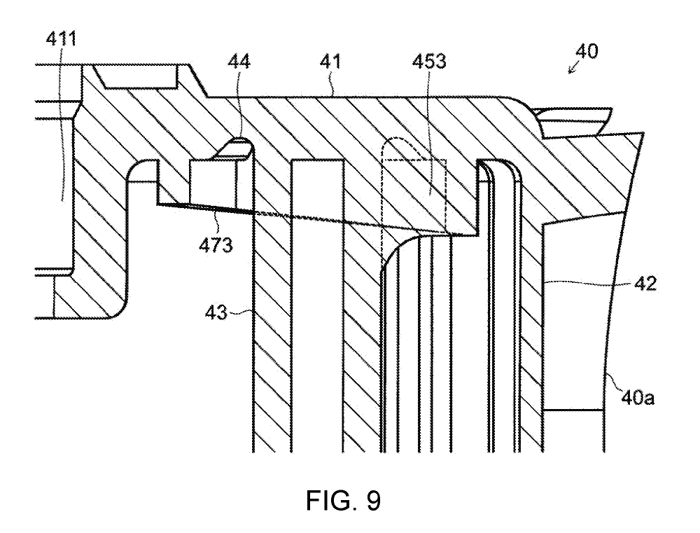

FIG. 9 is a partial vertical sectional view of a housing 40 of a motor 1 according to a third modification of the present example embodiment. The housing 40 of the motor 1 according to the third modification includes ribs 453 and wall portions 473.

The ribs 453 are arranged around each of projecting portions 43 axially below a top plate portion 41. Each rib 453 is arranged to connect the corresponding projecting portion 43 and the corresponding wall portion 473 to each other.

Each wall portion 473 is arranged around the corresponding projecting portion 43 axially below the top plate portion 41. The wall portion 473 is tubular, extending axially downward, is arranged to be concentric with the corresponding projecting portion 43, and is arranged to surround the corresponding projecting portion 43. The axial dimension of the wall portion 473 is arranged to decrease with decreasing distance from a central axis C. In other words, the axial position of an axially lower end of the wall portion 473 varies in a direction perpendicular to the axial direction. This arrangement makes it possible to change the mass of the housing 40 in any desired manner, and makes it possible to adjust a characteristic value of the motor 1. In addition, the above arrangement allows the shape of the wall portion 473 to be changed to any desired shape in accordance with objects contained in the housing 40.

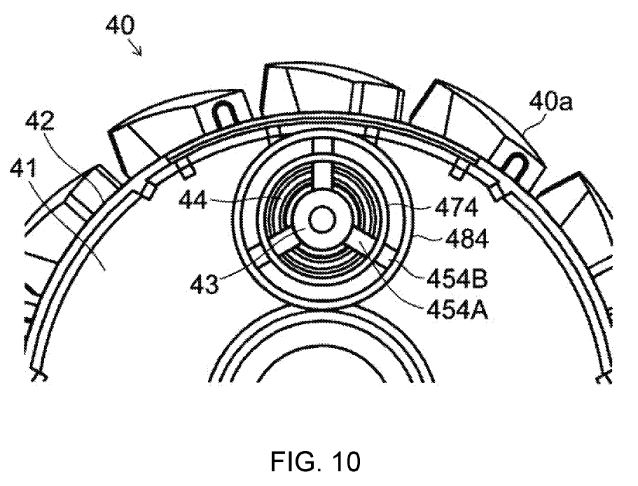

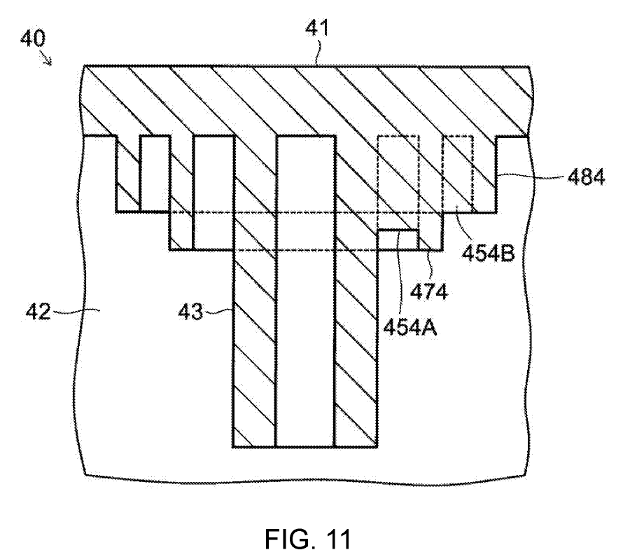

FIG. 10 is a partial bottom view of a housing 40 of a motor 1 according to a fourth modification of the present example embodiment. FIG. 11 is a vertical sectional view of a projecting portion 43 of the housing 40 of the motor 1 according to the fourth modification and its vicinity. The housing 40 of the motor 1 according to the fourth modification includes wall portions 474, outer wall portions 484, and ribs 454A and 454B.

Each wall portion 474 is arranged around the corresponding projecting portion 43 axially below a top plate portion 41. The wall portion 474 is tubular, extending axially downward, is arranged to be concentric with the corresponding projecting portion 43, and is arranged to surround the corresponding projecting portion 43.

Each outer wall portion 484 is arranged around the corresponding wall portion 474 axially below the top plate portion 41. The outer wall portion 484 is tubular, extending axially downward, is arranged to be concentric with the corresponding projecting portion 43 and the corresponding wall portion 474, and is arranged to surround the corresponding wall portion 474. That is, the housing 40 includes the outer wall portion 484 arranged to surround the corresponding wall portion 474. With this arrangement, an increase in rigidity of a base portion of the projecting portion 43 can be achieved through the wall portion 474 and the outer wall portion 484. This makes it possible to improve an effect of reducing vibration of the motor 1.

For example, the outer wall portion 484 is arranged to have an axial dimension smaller than that of the wall portion 474. In other words, the wall portion 474 and the outer wall portion 484 are arranged to have different axial dimensions. This arrangement makes it possible to change the mass of the housing 40 in any desired manner, and makes it possible to adjust a characteristic value of the motor 1. In addition, the above arrangement allows each of the shape of the wall portion 474 and the shape of the outer wall portion 484 to be changed to any desired shape in accordance with objects contained in the housing 40.

The ribs 454A are arranged around each projecting portion 43 axially below the top plate portion 41. The ribs 454B are arranged around each wall portion 474 axially below the top plate portion 41. The housing 40 has three of the ribs 454A and three of the ribs 454B provided for each projecting portion 43.

Each rib 454A is arranged to connect the corresponding projecting portion 43 and the corresponding wall portion 474 to each other. Each rib 454B is arranged to connect the corresponding wall portion 474 and the corresponding outer wall portion 484 to each other. The ribs 454B and the ribs 454A are connected to the corresponding wall portion 474 at the same positions. That is, the ribs 454A and 454B which are adjacent to each other with the wall portion 474 therebetween are arranged to extend from the corresponding projecting portion 43 in a straight line in a direction that is not parallel to the axial direction. Note that the ribs 454B and the ribs 454A may alternatively be connected to the corresponding wall portion 474 at different positions. Also note that the number of ribs 454B may alternatively be different from the number of ribs 454A.

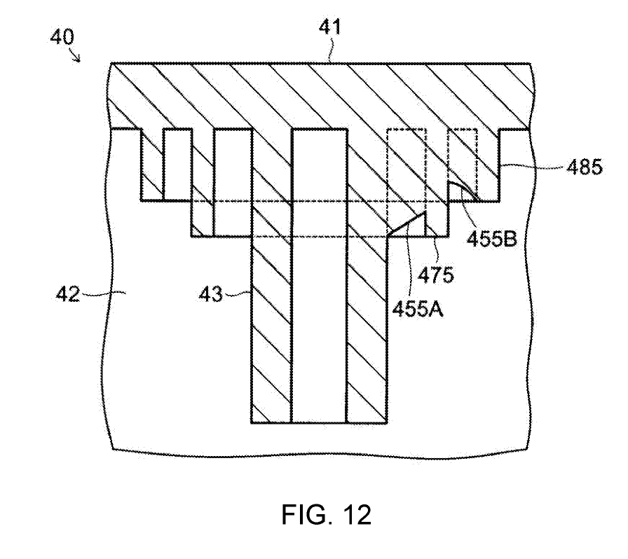

FIG. 12 is a vertical sectional view of a projecting portion 43 of a housing 40 of a motor 1 according to a fifth modification of the present example embodiment and its vicinity. The housing 40 of the motor 1 according to the fifth modification includes wall portions 475, outer wall portions 485, and ribs 455A and 455B.

Each wall portion 475 is arranged around the corresponding projecting portion 43 axially below a top plate portion 41. The wall portion 475 is tubular, extending axially downward, is arranged to be concentric with the corresponding projecting portion 43, and is arranged to surround the corresponding projecting portion 43.

Each outer wall portion 485 is arranged around the corresponding wall portion 475 axially below the top plate portion 41. The outer wall portion 485 is tubular, extending axially downward, is arranged to be concentric with the corresponding projecting portion 43 and the corresponding wall portion 475, and is arranged to surround the corresponding wall portion 475.

The ribs 455A are arranged around each projecting portion 43 axially below the top plate portion 41. Each rib 455A is arranged to connect the corresponding projecting portion 43 and the corresponding wall portion 475 to each other. An axially lower surface of the rib 455A is angled with respect to a plane perpendicular to the axial direction. The axial dimension of the rib 455A is arranged to decrease with increasing distance from the corresponding projecting portion 43. This arrangement makes it easier to form the housing 40.

The ribs 455B are arranged around each wall portion 475 axially below the top plate portion 41. Each rib 455B is arranged to connect the corresponding wall portion 475 and the corresponding outer wall portion 485 to each other. An axially lower surface of the rib 455B is arranged to curve with respect to a plane that crosses the axial direction. The axial dimension of the rib 455B is arranged to increase with increasing distance from the corresponding projecting portion 43.

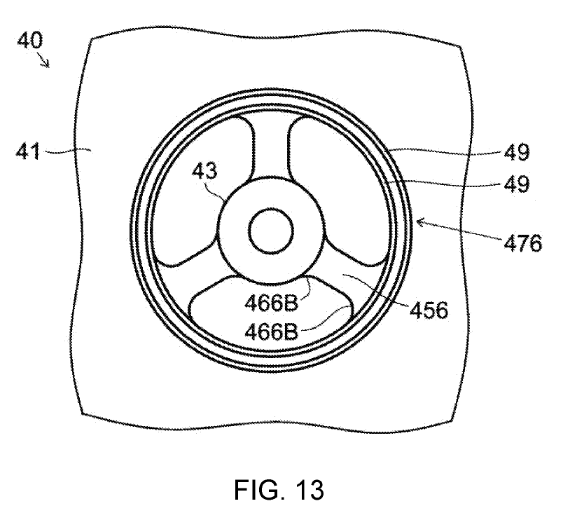

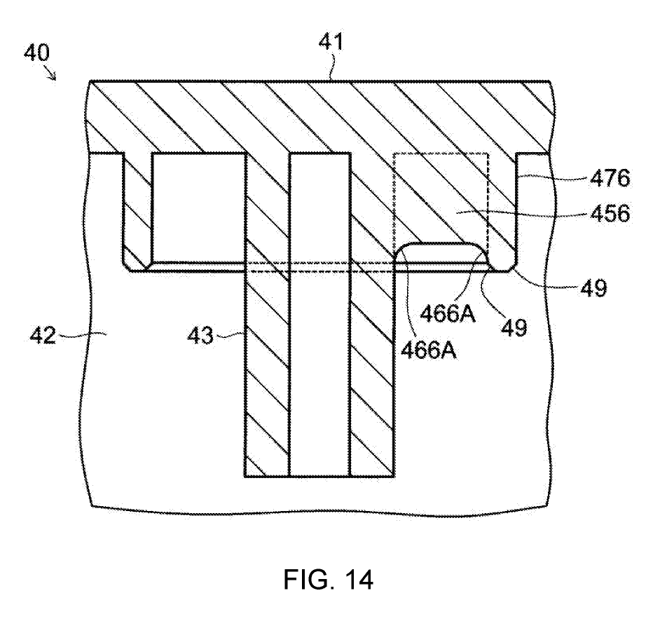

FIG. 13 is a partial bottom view of a projecting portion 43 of a housing 40 of a motor 1 according to a sixth modification of the present example embodiment and its vicinity. FIG. 14 is a vertical sectional view of the projecting portion 43 of the housing of the motor 1 according to the sixth modification and its vicinity. The housing 40 of the motor 1 according to the sixth modification includes ribs 456 and wall portions 476.

The ribs 456 are arranged around each projecting portion 43 axially below a top plate portion 41. Each rib 456 is arranged to connect the corresponding projecting portion 43 and the corresponding wall portion 476 to each other.

An axially lower surface of the rib 456 includes curved portions 466A. The curved portions 466A are arranged at a junction of the rib 45 with the projecting portion 43 and a junction of the rib 45 with the wall portion 476. Each curved portion 466A is arranged to curve axially downward as it approaches the projecting portion 43 or the wall portion 476.

A side surface of the rib 456, the side surface extending along the axial direction, includes curved portions 466B. The curved portions 466B are arranged at the junction of the rib 45 with the projecting portion 43 and the junction of the rib 45 with the wall portion 476. Each curved portion 466B is arranged to curve in a direction that is not parallel to the axial direction as it approaches the projecting portion 43 or the wall portion 476.

Each wall portion 476 is arranged around the corresponding projecting portion 43 axially below the top plate portion 41. The wall portion 476 is tubular, extending axially downward, is arranged to be concentric with the corresponding projecting portion 43, and is arranged to surround the corresponding projecting portion 43. Corner portions of the wall portion 476 at an axially lower end thereof include slanting surfaces each of which is angled with respect to each of the axial direction and a direction perpendicular to the axial direction. That is, the wall portion 476 includes chamfer portions 49 at the axially lower end thereof. This arrangement makes it possible to change the mass of the housing 40 in any desired manner, and makes it possible to adjust a characteristic value of the motor 1. In addition, the above arrangement makes it easier to bring an object contained in the housing 40 into contact with the wall portion 476. Note that, although the chamfer portions 49 are arranged at an inner circumferential portion and an outer circumferential portion of the axially lower end of the wall portion 476, only one of the chamfer portions 49 may be provided.

The blower apparatus 100 according to the present example embodiment includes the motor 1 having the above-described structure, and the impeller 110 fixed to the shaft 10. Thus, the blower apparatus 100 is able to achieve an increase in the rigidity of the housing 40 of the motor 1. This leads to reduced vibration of the blower apparatus 100.

The characteristic value of the motor 1 corresponds to a frequency specific to the motor 1. In the blower apparatus 100, the characteristic value of the motor 1 may cause resonance to generate vibrations. A reduction in the vibration of each of the motor 1 and the blower apparatus 100 can be achieved by changing the characteristic value of the motor 1 according to the present example embodiment to a desired frequency to prevent resonance vibration.

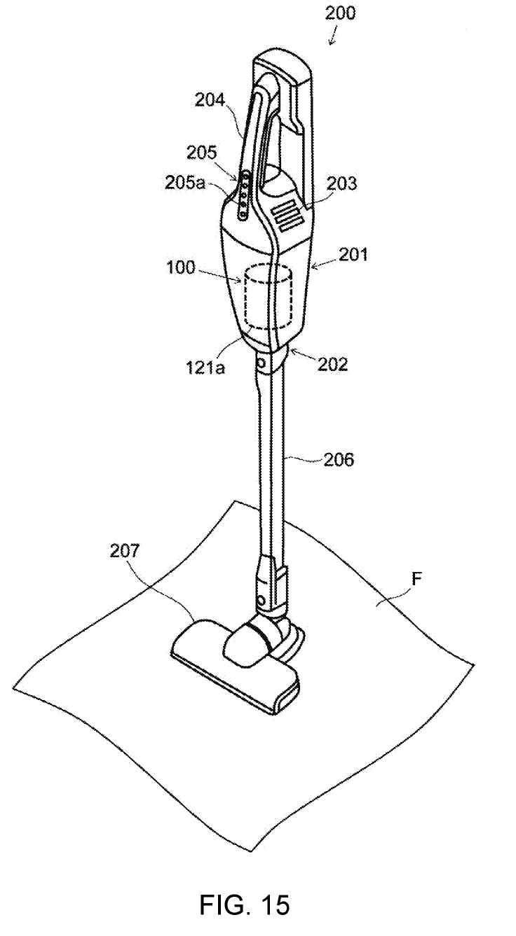

FIG. 15 is a perspective view of a vacuum cleaner 200 according to an example embodiment of the present disclosure. The vacuum cleaner 200 includes the blower apparatus 100 having the above-described structure. That is, the vacuum cleaner 200 includes the motor 1 having the above-described structure. The vacuum cleaner 200 is a so-called stick-type electric vacuum cleaner. Note that the vacuum cleaner 200 may alternatively be any type of electric vacuum cleaner, including a so-called robot-type electric vacuum cleaner, a canister-type electric vacuum cleaner, and a handy-type electric vacuum cleaner.

The vacuum cleaner 200 includes a casing 201 having an air inlet portion 202 and an air discharge portion 203 opening in a lower surface and an upper surface, respectively, of the casing 201. The vacuum cleaner 200 has a battery (not shown) arranged inside of the casing 201, and is arranged to operate through power supplied from the battery. Note that the vacuum cleaner 200 may alternatively be arranged to include a power supply cord, and to operate through power supplied through the power supply cord connected to a power socket installed in, for example, a wall of a room.

An air passage (not shown), which connects the air inlet portion 202 and the air discharge portion 203 to each other, is arranged inside of the casing 201. In the air passage, a dust collection portion (not shown), a filter (not shown), and the blower apparatus 100 are arranged in the order named from an upstream side to a downstream side in a direction of air flow. In the vacuum cleaner 200, the blower apparatus 100 is arranged such that the air inlet 121a faces downward. Waste included in an air flowing in the air passage, such as, for example, dust, is captured by the filter, and is collected in the dust collection portion, which is in the shape of a receptacle. The vacuum cleaner 200 is thus able to clean a floor F. Note that each of the dust collection portion and the filter is arranged to be detachable from the casing 201.

A handle portion 204 and an operation portion 205 are arranged at an upper portion of the casing 201. A user is able to grasp the handle portion 204 and move the vacuum cleaner 200. The operation portion 205 includes a plurality of buttons 205a. The user is able to instruct the vacuum cleaner 200 to operate in a desired manner, and perform an operation setting on the vacuum cleaner 200, by operating the buttons 205a. For example, by operating the buttons 205a, the user is able to issue an instruction to, for example, start the blower apparatus 100, stop the blower apparatus 100, or change the rotation rate of the blower apparatus 100.

A downstream end of a suction pipe 206, which is arranged to extend substantially in a straight line, i.e., an upper end of the suction pipe 206 in FIG. 15, is connected to the air inlet portion 202. A suction nozzle 207 is detachably attached to the suction pipe 206 at an upstream end of the suction pipe 206, i.e., at a lower end of the suction pipe 206 in FIG. 15.

As described above, the vacuum cleaner 200 includes the blower apparatus 100. Thus, in the vacuum cleaner 200, an increase in the rigidity of the housing 40 of the motor 1 can be achieved. This leads to reduced vibration of the vacuum cleaner 200.

Note that the blower apparatus 100 may alternatively be installed in devices other than the vacuum cleaner, including various types of office automation appliances, medical appliances, transportation equipment, and household electrical appliances other than vacuum cleaners.

Example embodiments of the present disclosure are applicable to electrical appliances including a blower apparatus, such as, for example, vacuum cleaners.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor that is rotatable about a central axis extending in a vertical direction;
a stator that is radially opposite to the rotor; and
a housing to contain at least a portion of each of the rotor and the stator; wherein
the stator includes:
a core back; and
a plurality of teeth each extending from the core back toward the central axis;
the housing includes:
a top plate extending perpendicularly or substantially perpendicularly to the central axis;
a tubular housing portion extending axially downward from a radially outer end of the top plate; and
at least one projection extending axially downward from the top plate and located between adjacent ones of the teeth in a circumferential direction.

2. The motor according to claim 1, further comprising a cover located axially below the stator and axially opposite to the top plate, wherein an axially lower end of the at least one projection is connected to the cover.

3. The motor according to claim 2, further comprising a pair of bearings, wherein
one of the pair of bearings is held by the housing;
another one of the pair of bearings is held by the cover; and
the housing and the cover are connected to each other at the at least one projection.

4. The motor according to claim 1, wherein the housing includes a recess that is recessed axially upward around the at least one projection.

5. The motor according to claim 1, wherein the housing includes at least one rib extending from the at least one projection in a direction that is not parallel to the central axis.

6. The motor according to claim 5, wherein the at least one rib is structured to connect the at least one projection and the tubular housing portion to each other.

7. The motor according to claim 1, wherein the housing includes:
a rib extending from the at least one projection in a direction that is not parallel to the central axis; and
a wall connected to the rib;
the wall extends axially downward from an axially lower surface of the top plate; and
the rib is structured to connect the at least one projection and the wall to each other.

8. The motor according to claim 7, wherein the wall is tubular and surrounds the at least one projection.

9. The motor according to claim 7, wherein the housing includes an outer wall surrounding the wall.

10. The motor according to claim 9, wherein the wall and the outer wall have different axial dimensions.

11. The motor according to claim 5, wherein an axial dimension of the rib decreases with increasing distance from the at least one projection.

12. The motor according to claim 5, wherein an axially lower surface of the rib includes a curved portion.

13. The motor according to claim 7, wherein the wall includes a chamfered portion at an axially lower end thereof.

14. A blower apparatus comprising:
the motor of claim 1; and
an impeller fixed to a rotating shaft of the rotor.

15. A vacuum cleaner comprising the blower apparatus of claim 14.
